(19) United States
(12) Patent Application Publication
(10) Pub. No.: US 2018/0339883 A1
(43) Pub. Date: Nov. 29, 2018

(54) MACHINE ASSEMBLY AND ELEVATOR

(71) Applicant: Otis Elevator Company, Farmington, CT (US)

(72) Inventors: Yunzhu Shen, Shanghai (CN); Chuanyong Zhou, Shanghai (CN); Benjamin Watson, Collinsville, CT (US)

(21) Appl. No.: 15/986,017

(22) Filed: May 22, 2018

(30) Foreign Application Priority Data
May 23, 2017 (CN) 201710367977.0

(51) Int. Cl. B66B 11/00

(52) U.S. Cl. CPC B66B 11/0005; B66B 11/0045; B66B 11/004

(57) ABSTRACT

The present invention provides a tractor assembly and an elevator. The tractor assembly includes: a rack; multiple tractors; and multiple traction parts connected to an elevator car and an elevator counterweight respectively via the tractors; wherein the multiple tractors are mounted on the rack respectively, and are staggered along a horizontal direction; the vertical direction extends along an elevator hoistway, and the horizontal direction transects the elevator hoistway to extend. With such arrangement, on the one hand, arrangement of two tractors is implemented without making too many changes to an existing structure space; on the other hand, compared with a unit that uses a heavy load tractor, the product cost can be reduced significantly while achieving basically the same technical effect. In addition, the use of two tractors of a relatively small size also implements machine room-free or small machine room arrangement.

### FOREIGN PRIORITY

This application claims priority to Chinese Patent Application No. 201710367977.0, filed May 23, 2017, and all the benefits accruing therefrom under 35 U.S.C. § 119, the contents of which in its entirety are herein incorporated by reference.

### TECHNICAL FIELD

The present invention relates to the field of elevators, and in particular, to a tractor assembly of an elevator.

### BACKGROUND ART

At present, with the increase of the elevator workload and the lifting distance, developers also need to use increasingly larger tractors to operate elevators. However, for such a tractor, its manufacturing cost is not simply increased linearly as the workload increases. In fact, when a required workload increases, the corresponding manufacturing cost of the tractor will grow exponentially. In this case, if multiple tractors with a small workload are used to replace a tractor with a large workload, the cost can be reduced significantly while a similar work requirement is met. However, how to arrange multiple tractors in a mounting space becomes a problem to be urgently solved in practical application of such a technology.

### SUMMARY OF THE INVENTION

An objective of the present invention is to provide a tractor assembly that can achieve a high workload at a low cost.

Another objective of the present invention is to provide an elevator that can achieve a high workload at a low cost.

To achieve the objective of the present invention, according to one aspect, a tractor assembly is provided, which includes: a rack; multiple tractors; and multiple traction parts connected to an elevator car and an elevator counterweight respectively via the tractors; wherein the multiple tractors are mounted on the rack respectively, and are staggered along a horizontal direction; the vertical direction extends along an elevator hoistway, and the horizontal direction transects the elevator hoistway to extend.

To achieve the another objective of the present invention, according to another aspect, an elevator is further provided, which includes: an elevator car, an elevator counterweight, and a tractor assembly; wherein the tractor assembly includes a rack, multiple tractors, and multiple traction parts; the traction parts are connected to the elevator car and the elevator counterweight respectively via the tractors; wherein the multiple tractors are mounted on the rack respectively, and are staggered along a horizontal direction; the vertical direction extends along an elevator hoistway, and the horizontal direction transects the elevator hoistway to extend.

### BRIEF DESCRIPTION OF THE DRAWINGS

FIG. 1 is a schematic exploded view of an embodiment of a tractor assembly according to the present invention;

FIG. 2 is a schematic assembly diagram of an embodiment of a tractor assembly according to the present invention;

FIG. 3 is a schematic exploded view of another embodiment of a tractor assembly according to the present invention;

FIG. 4 is a schematic assembly diagram of another embodiment of a tractor assembly according to the present invention;

FIG. 5 is a brief top view of relative mounting positions of a tractor assembly and a car as well as a counterweight according to the present invention; and

FIG. 6 is a schematic diagram of a connection relationship between a tractor assembly and a car as well as a counterweight according to the present invention.

### DETAILED DESCRIPTION

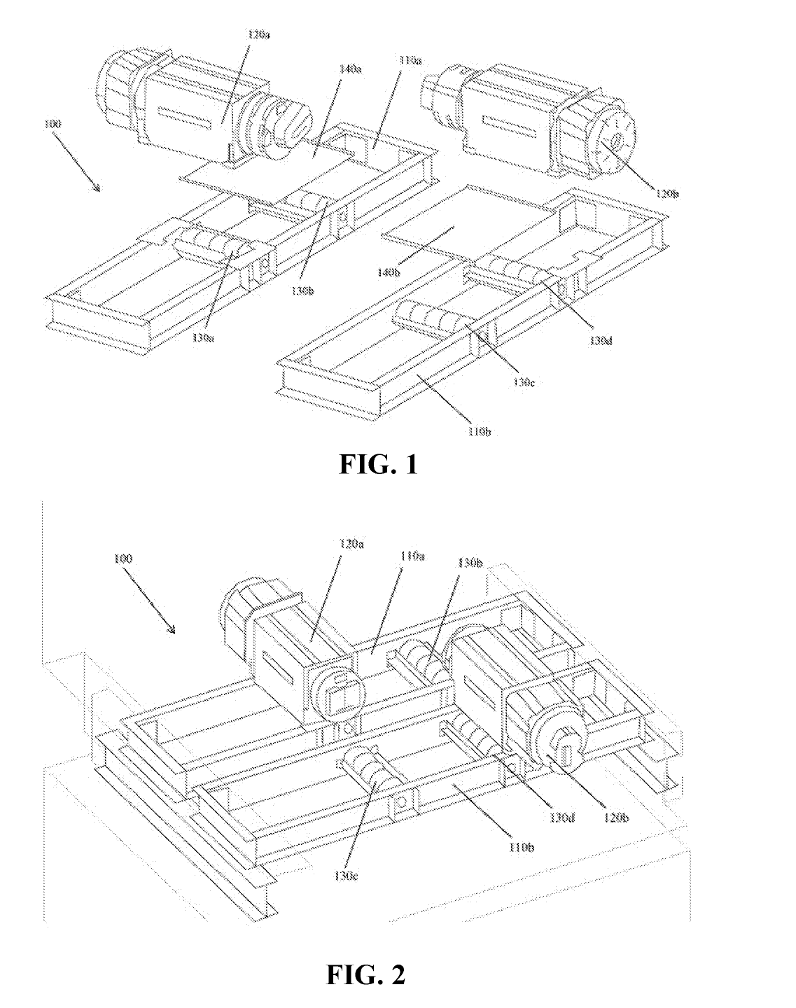

Referring to FIG. 1 and FIG. 2, an embodiment of a tractor assembly according to the conception is shown. The tractor assembly 100 includes: two racks 110a and 110b; two tractors 120a and 120b disposed in parallel; and two sets of traction belts 150a and 150b, wherein the two sets of traction belts 150a and 150b are connected to an elevator car 200 and an elevator counterweight 300 respectively via the two tractors 120a and 120b. In the tractor assembly 100, the two tractors 120a and 120b are mounted on the racks 110a and 110b respectively, and are staggered along a horizontal direction. With such arrangement, on the one hand, arrangement of two tractors is implemented without making too many changes to an existing structure space; on the other hand, compared with a unit that uses a heavy load tractor, the product cost can be reduced

It should be known that, although the solution is described with two racks 110a and 110b, two tractors 120a and 120b and two sets of traction belts 150a and 150b in the forgoing embodiment, the numbers of the parts are not the only choice. In fact, many aspects such as the size of the arrangement space, the product cost and the mounting convenience should all be taken into comprehensive consideration, and the most appropriate number of tractors that should be equipped for an elevator product in an actual application can be obtained accordingly. Moreover, it is more appropriate to equip each tractor with a rack and a set of traction belts correspondingly. In the solution conceived in this embodiment, one optional solution is two tractors, and three or more tractors may also be selected.

Referring to FIG. 1 and FIG. 2, in a horizontally staggered arrangement manner, more specifically, one of the two tractors 120a and 120b is arranged in a relative left position in the figure, while the other one is arranged in a relative right position in the figure. Thus, the space can be utilized more effectively, and mutual interference caused by movements of traction belts drawn by two tractors can be avoided.

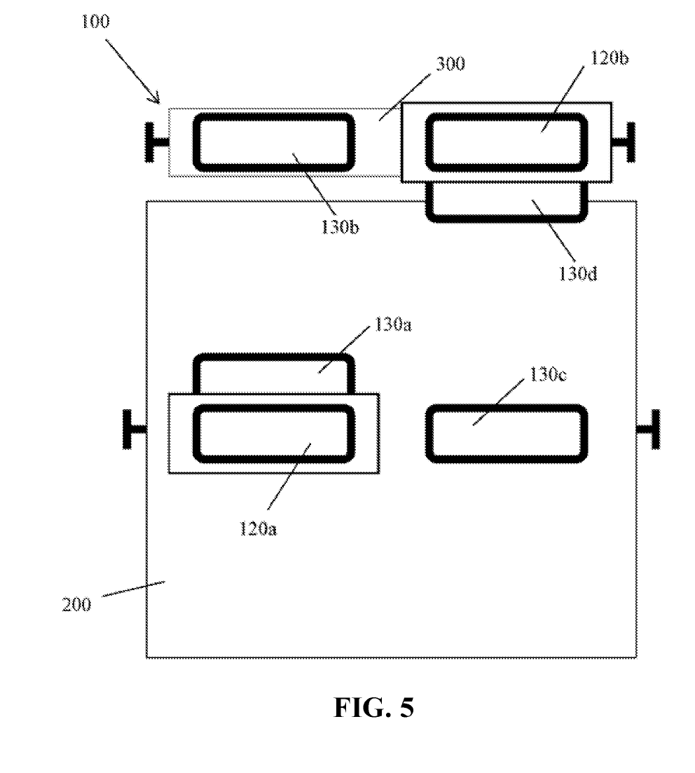

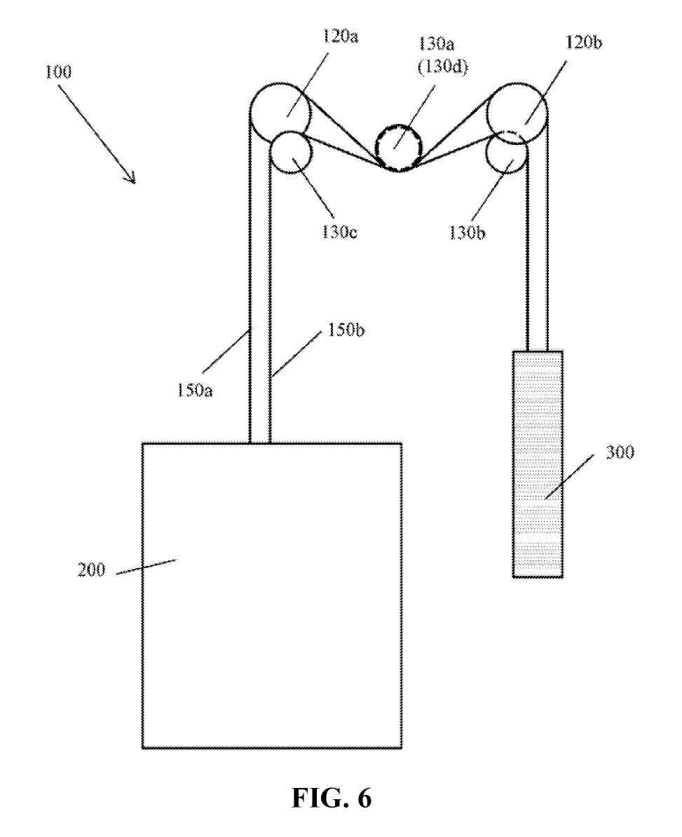

In fact, as further shown in FIG. 5 and FIG. 6 subsequently, the tractor 120a on the left is actually arranged above the elevator car, while the tractor 120b on the right is actually arranged above the elevator counterweight. As such, it can better avoid mutual interference caused by movements of the tractors, and the space is reasonably utilized. Moreover, in this case, the tractor 120a will be directly connected to the car via traction, while the tractor 120b will be directly connected to the counterweight 300 via traction, thus avoiding the loss of force transmission caused by multiple transfer parts.

Definitely, specific spatial arrangement positions of two tractors in FIG. 5 and FIG. 6 are only an example. Similarly, although not shown in the figures, the two tractors can also be both arranged above the elevator car, as long as they are staggered in the horizontal direction at the same time. Also similarly, the relative positions between the tractors and traction wheels can also be adjusted to adapt to different spatial requirements and transmission requirements.

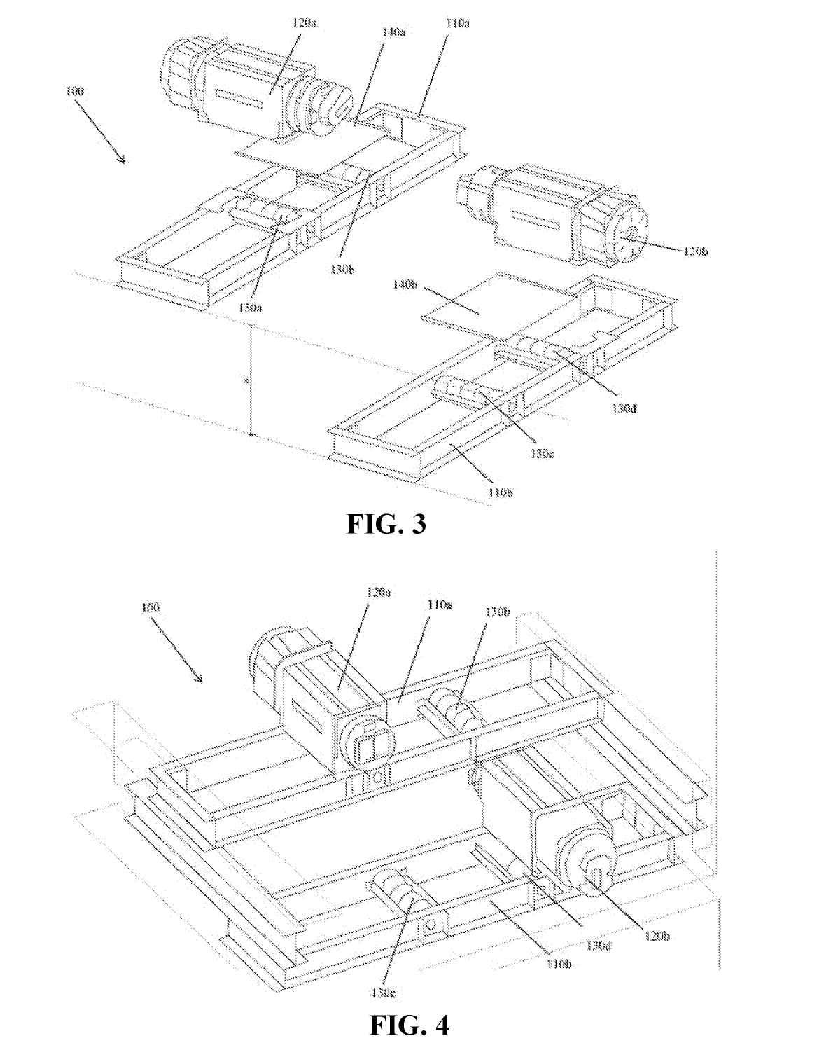

Optionally, referring to FIG. 3 and FIG. 4, as another arrangement manner, the two tractors 120a and 120b can also be staggered along a vertical direction. More specifically, one of the two tractors 120a and 120b is arranged in a relative upper position along a hoistway, while the other one is arranged in a relative lower position along the hoistway, such that the two tractors are staggered at a height H in the vertical direction. Such an arrangement manner can also utilize the space more effectively, and can avoid mutual interference caused by movements of traction belts drawn by the two tractors.

As another optional solution, it is possible to combine the above two arrangement manners, that is, stagger the two tractors 120a and 120b in the horizontal direction and the vertical direction at the same time, to further prevent occurrence of interference. This example is also shown in FIG. 3 and FIG. 4.

Herein, it should be known that, the vertical direction and the horizontal direction described above should normally use the hoistway as a reference standard. That is, the arrangement along the vertical direction indicates staggering the multiple traction parts in an extending direction of the length of the hoistway, such that a part of the tractors is arranged higher than the other part. The arrangement along the horizontal direction indicates staggering the multiple traction parts in a direction of transecting the hoistway to extend, such that rotation axes of a part of the tractors and rotation axes of the other part of the tractors are staggered on the horizontal plane.

The structural and connection relationships between the parts therein are specifically described in the following.

The racks 110a and 110b each include a mounting frame. The mounting frame is constructed substantially as a rectangle and is formed by surrounding four borders. A set of fixed traction pulleys 130a and 130b is disposed on inner sides of two opposite long borders of the first mounting frame, and a set of fixed traction pulleys 130c and 130d is disposed on inner sides of two opposite long borders of the second mounting frame. With such arrangement, the tractors 120a and 120b each correspond to a mounting frame and a set of fixed traction pulleys 130a, 130b, 130c and 130d respectively, thus forming two sets of traction drive systems that can move independently and have a rope ratio of 1:1. The elevator car and the elevator counterweight can be drawn by operating either or both of the two sets of traction drive systems. A set of fixed traction pulleys and a tractor can draw a limited number of traction belts, for example, the number is generally 4-5 at most. In this case, two sets of fixed traction pulleys and two tractors can draw up to 8-10 traction belts. This can effectively avoid sinking and oscillation problems occurring when the elevator is in an operating state or a stop state, thus improving the reliability and comfort of taking the elevator.

In this case, the borders of the multiple mounting frames should be provided with connecting portions matched with each other, such that they can be connected into a whole.

Definitely, it is also possible to construct the whole rack into a mounting frame and dispose multiple fixed traction pulleys 130a, 130b, 130c and 130d in the mounting frame. The traction belts 150a and 150b are connected to the elevator car 200 and the elevator counterweight 300 respectively via the tractors 120a and 120b and the fixed traction pulleys 130a, 130b, 130c and 130d. In this case, the traction on the elevator car and the elevator counterweight can also be achieved.

Moreover, a rope ratio of the tractor assembly 100 is 1:1, thus reducing the quantity of the traction belts significantly. For example, when the traction belts are steel belts or steel wire ropes, the quantity of the steel belts or steel wire ropes can be reduced greatly.

In addition, the solution of movable traction pulleys whose rope ratio is 2:1 can also be used. Although not shown in the figures, movable traction pulleys can be disposed on the elevator car 200 and the elevator counterweight 300 respectively, thus achieving the traction on the elevator car and the elevator counterweight.

Optionally, to enhance the installation firmness of the tractors and the racks, mounting base plates 140a and 140b may be further disposed on the racks 110a and 110b, for providing the tractors 120a and 120b with mounting positions.

Optionally, to ensure that the output torque of multiple tractors can be superimposed and coordinated well and that the delay start or the following problems can be avoided, on/off of the multiple tractors should be able to be controlled in a linked manner.

According to another aspect of the conception, an embodiment of an elevator is further provided. Referring to FIG. 5 and FIG. 6, the elevator includes an elevator car 200, an elevator counterweight 300, and a tractor assembly 100. The tractor assembly 100 includes two racks 110a and 110b, two tractors 120a and 120b, and two sets of traction belts 150a and 150b. The two sets of traction belts 150a and 150b are connected to the elevator car 200 and the elevator counterweight 300 respectively via the tractors 120a and 120b. The two tractors 120a and 120b are mounted to the two racks 110a and 110b respectively, and are staggered along a horizontal direction. More specifically, the tractor 120a is arranged above the elevator car 200 along the horizontal direction, while the tractor 120b is arranged above the elevator counterweight 300 along the horizontal direction. With such arrangement, on the one hand, arrangement of two tractors is implemented without making too many changes to an existing structure space; on the other hand, compared with a unit that uses a heavy load tractor, the product cost can be reduced significantly while achieving basically the same technical effect.

Optionally, as an embodiment of several arrangement spaces, the racks 110a and 110b can be mounted in the elevator hoistway or an elevator machine room. On the one hand, owing to the reduction of the product size, when the tractor assembly is arranged in the elevator machine room, the space dimension of the machine room can be reduced, so that the design of a small machine room can be achieved. On the other hand, when the tractor assembly is directly arranged above the elevator hoistway, even the machine room can be directly saved, so that the machine room-free design can be achieved.

In addition, the tractor assembly has good applicability, which can be applied to a number of mounting forms such as the elevator counterweight 300 is a lateral elevator counterweight and/or a rear elevator counterweight.

An operating process of an elevator according to an embodiment of the conception will be described below with reference to FIG. 4. First of all, when the elevator operates, the load that originally needs to be provided by one tractor is now provided by the two tractors 120a and 120b respectively, the product cost is reduced greatly on the premise of achieving similar load. Then, under the drive of the tractors 120a and 120b, the tractor belts 150a and 150b achieve relative displacement between the elevator car 200 and the elevator counterweight 300 via traction and compression of the fixed traction pulleys 130a, 130b, 130c and 130d. For example, the elevator counterweight 300 descends when the elevator car 200 rises; the elevator counterweight 300 rises when the elevator car 200 descends. In addition, when the elevator car 200 stops on a particular floor, the elevator car may not sink and oscillate excessively during stop and start as the tractor assembly in this embodiment has up to 8-10 steel traction belts, thus greatly improving the user's comfort of taking the elevator.

The above examples mainly describe the tractor assembly and the elevator of the present invention. Although only some implementation manners of the present invention are described, those of ordinary skill in the art should understand that the present invention can be implemented in many other forms without departing from the purport and scope thereof. Therefore, the examples and implementation manners are regarded as exemplary instead of being limitative, the present invention can cover a variety of modifications and replacements without departing from the spirit and scope of the present invention as defined by the appended claims.

1. A tractor assembly, comprising:
a rack;
multiple tractors; and
multiple traction parts connected to an elevator car and an elevator counterweight respectively via the tractors,
wherein the multiple tractors are mounted on the rack respectively, and are staggered along a horizontal direction and/or along a vertical direction; the vertical direction extends along an elevator hoistway, and the horizontal direction transects the elevator hoistway to extend.

2. The tractor assembly according to claim 1, wherein a part of the multiple tractors is arranged above the elevator car, and the other part of the multiple tractors is arranged above the elevator counterweight.

3. The tractor assembly according to claim 1, wherein the rack is constructed as a mounting frame in which multiple fixed traction pulleys are disposed; the traction parts are connected to the elevator car and the elevator counterweight respectively via the tractors and the fixed traction pulleys; and a rope ratio of the tractor assembly is 1:1.

4. The tractor assembly according to claim 1, wherein the rack comprises multiple mounting frames in each of which a set of fixed traction pulleys is disposed respectively; the tractors each correspond to a mounting frame and a set of fixed traction pulleys; and a rope ratio of the tractor assembly is 1:1.

5. The tractor assembly according to claim 4, wherein borders of the multiple mounting frames are provided with connecting portions matched with each other.

6. The tractor assembly according to claim 1, further comprising movable traction pulleys disposed on the elevator car and the elevator counterweight respectively, and a rope ratio of the tractor assembly being 2:1.

7. The tractor assembly according to claim 1, wherein the rack is provided with a mounting base plate, for providing mounting positions of the tractors.

8. The tractor assembly according to claim 1, wherein the traction parts are steel belts or steel wire ropes.

9. The tractor assembly according to claim 1, wherein the tractor assembly comprises two tractors.

10. The tractor assembly according to claim 1, wherein on/off of the multiple tractors can be controlled in a linked manner.

11. An elevator, comprising an elevator car, an elevator counterweight, and a tractor assembly; wherein the tractor assembly comprises a rack, multiple tractors, and multiple traction parts; the traction parts are connected to the elevator car and the elevator counterweight respectively via the tractors; wherein the multiple tractors are mounted on the rack respectively, and are staggered along a horizontal direction and/or along a vertical direction; the vertical direction extends along an elevator hoistway, and the horizontal direction transects the elevator hoistway to extend.

12. The elevator according to claim 11, wherein a part of the multiple tractors is arranged above the elevator car, and the other part of the multiple tractors is arranged above the elevator counterweight.

13. The elevator according to claim 11, wherein the rack is constructed as a mounting frame in which multiple fixed traction pulleys are disposed; the traction parts are connected to the elevator car and the elevator counterweight respectively via the tractors and the fixed traction pulleys; and a rope ratio of the tractor assembly is 1:1.

14. The elevator according to claim 11, wherein the rack comprises multiple mounting frames in each of which a set of fixed traction pulleys is disposed respectively; the tractors each correspond to a mounting frame and a set of fixed traction pulleys; and a rope ratio of the tractor assembly is 1:1.

15. The elevator according to claim 14, wherein borders of the multiple mounting frames are provided with connecting portions matched with each other.

16. The elevator according to claim 11, further comprising movable traction pulleys disposed on the elevator car and the elevator counterweight respectively, and a rope ratio of the tractor assembly being 2:1.

17. The elevator according to claim 11, wherein the rack is provided with a mounting base plate, for providing mounting positions of the tractors.

18. The elevator according to claim 11, wherein the traction parts are steel belts.

19. The elevator according to claim 11, wherein the tractor assembly comprises two tractors.

20. The elevator according to claim 11, wherein on/off of the multiple tractors can be controlled in a linked manner.

21. The elevator according to claim 11, wherein the rack is mounted in the elevator hoistway or an elevator machine room.

22. The elevator according to claim 11, wherein the elevator counterweight is a lateral elevator counterweight and/or a rear elevator counterweight.
